(19) United States
(12) Patent Application Publication
(10) Pub. No.: US 2011/0035920 A1
(43) Pub. Date: Feb. 17, 2011

(54) CLEANABLE SIGHT GLASS

(76) Inventor: Drew M. Robbins, Port Neches, TX (US)

Correspondence Address: CARSTENS & CAHOON, LLP, 13760 NOEL ROAD, SUITE 900, DALLAS, TX, 75240, US

(21) Appl. No.: 12/913,979

(22) Filed: Oct. 28, 2010

(51) Int. Cl. B23P 6/00; G01F 23/02

(52) U.S. Cl. 29/402.04; 73/324

(57) ABSTRACT

The present invention relates to a cleanable sight glass for installation on welded pads. In one embodiment of the invention, an adapter plate is provided to allow existing welded pad sight glasses to be retrofitted, allowing cleaning without disassembling the glass each time a cleaning is needed. The adapter plate mates between the original welded pad for the sight glass and the original top plate that was installed over the sight glass. The adapter plate contains ports on each end for the installation of plugs. The plugs can be removed and a brush can be used to clean the glass without disassembly of the welded pad sight glass. In an alternative embodiment, the ports for the plugs can be installed into the ends of the welded pad itself upon original manufacture of the particular piece of equipment so that an adapter plate is not needed. The welded pad should be made of thickness great enough to accommodate said ports.

### BACKGROUND OF THE INVENTION

Sight glasses have been utilized for many years to allow maintenance workers to view fluid levels in various types of machinery and equipment. Over time, the sight glasses will often become contaminated from the fluids or materials that pass over the glass. As a result, it may become difficult to make an accurate reading of fluid level in the particular piece of machinery or equipment.

While certain cleanable style sight glasses have been developed, there have been no cleanable sight glasses developed for sight glasses mounted onto a welded pad. Seal pots, for example, are widely used to contain a barrier fluid to keep mechanical seals lubricated and cool. The seal pots typically have a welded pad sight glass on them to view the level. However, the sight glass cannot currently be cleaned without disassembling the glass. The sight glass must be removed to clean or replace the sight glass. This task in most cases involves scheduling different crafts, parts, and time to accomplish the desired task of cleaning the sight glasses. Because of the amount of resources required, sight glasses on seal pots are often neglected. The neglect could cause potential seal damage which may result in substantial additional fees and expenses that are incurred in replacing the seal associated with the seal pot.

It would therefore be desirable to have a cleanable sight glass that can be installed on existing seal pots or newly manufactured seal pots to allow the sight glass to be cleaned without removing the glass.

### SUMMARY OF THE INVENTION

The present invention relates to a cleanable sight glass for installation on welded pads. In one embodiment of the invention, an adapter plate is provided to allow existing welded pad sight glasses to be retrofitted, allowing cleaning without disassembling the glass each time a cleaning is needed. The adapter plate mates between the original welded pad for the sight glass and the original plate that was installed over the sight glass. The adapter plate contains threaded ports on each end for the installation of plugs. The plugs can be removed and a brush can be used to clean the glass without disassembly of the welded pad sight glass. In an alternative embodiment, the ports for the plugs can be installed into the ends of the welded pad itself upon original manufacture of the particular piece of equipment so that an adapter plate is not needed. The welded pad should be made of thickness great enough to accommodate said ports.

### BRIEF DESCRIPTION OF THE DRAWINGS

FIG. 1 is a perspective view of a prior art welded base type sight glass.

FIG. 2 is a perspective view of a welded base sight glass that has been retrofitted to allow cleaning in accordance with an embodiment of the invention.

FIG. 3 is a perspective view of a cleanable welded base sight glass in accordance with an embodiment of the invention showing a brush being inserted to clean the sight glass.

FIG. 4 is a front view of an adapter plate in accordance with an embodiment of the invention.

FIG. 5 is a top view of an adapter plate in accordance with an embodiment of the invention.

FIG. 6 is a perspective view of a welded sight glass wherein the welded base is adapted for cleaning the sight glass in accordance with an embodiment of the invention.

### DETAILED DESCRIPTION

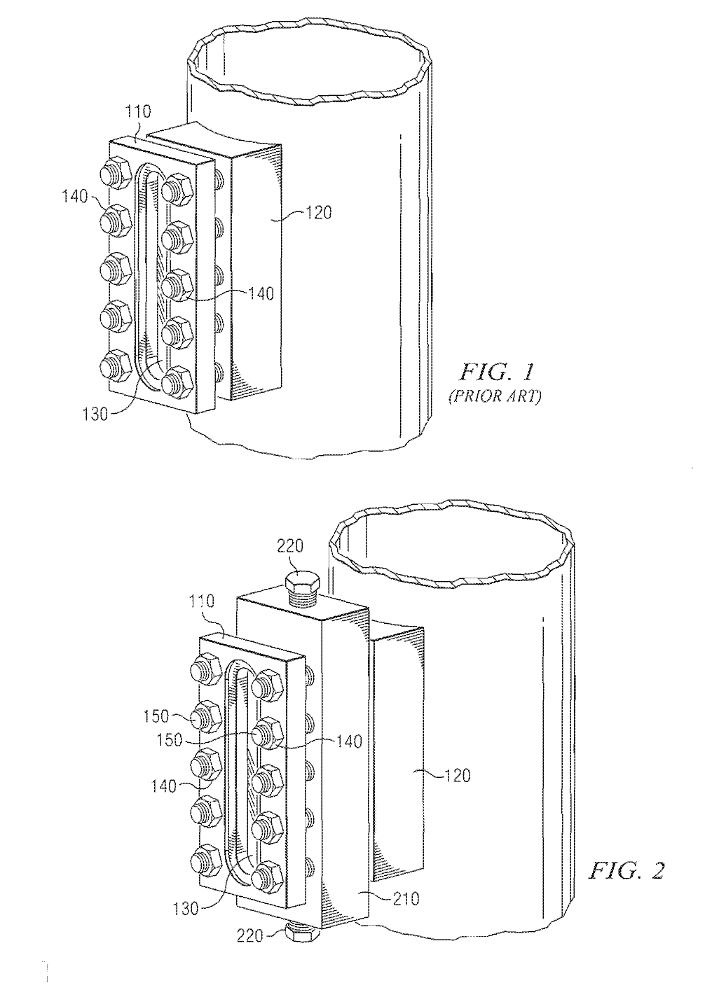

FIG. 1 is a perspective view of a prior art welded base type sight glass. The welded base sight glass illustrated in FIG. 1 requires that the top plate 110 be removed from the welded base plate 120 to clean sight glass 130. This is not a simple task in that numerous fasteners 140 must be removed to remove the top plate 110. The glass is then either cleaned or replaced and new gaskets installed before reinstalling the top plate 110. This is a rather cumbersome operation and can result in breakage of the glass during the removal process and cleaning of the old gasket from the glass.

FIG. 2 is a perspective diagram of a welded sight glass that has been retrofitted to allow cleaning in accordance with an embodiment of the invention. The sight glass depictured in FIG. 2 is retrofitted with an adapter plate 210. The adapter plate 210 is configured to mate with the welded base 120 on one side and with the top plate 110 on the opposing side. The adapter plate 210 contains a recessed mating area for a gasket and the glass to be inserted. Once inserted, the top plate 110 is affixed to the adapter plate 210 using studs 150 and nuts 140. The studs 150 will likely need to be longer than the original studs to accommodate the thickness of the adapter plate 210. By providing an adapter plate as is illustrated in FIG. 2, numerous welded base sight glasses in the field can be retrofitted relatively inexpensively to allow subsequent cleaning of the sight glass without removal of the top plate 110. Instead, one or both of the plugs 220 is removed to allow cleaning. In one embodiment, the plugs 220 are ¾ inch national pipe thread plugs.

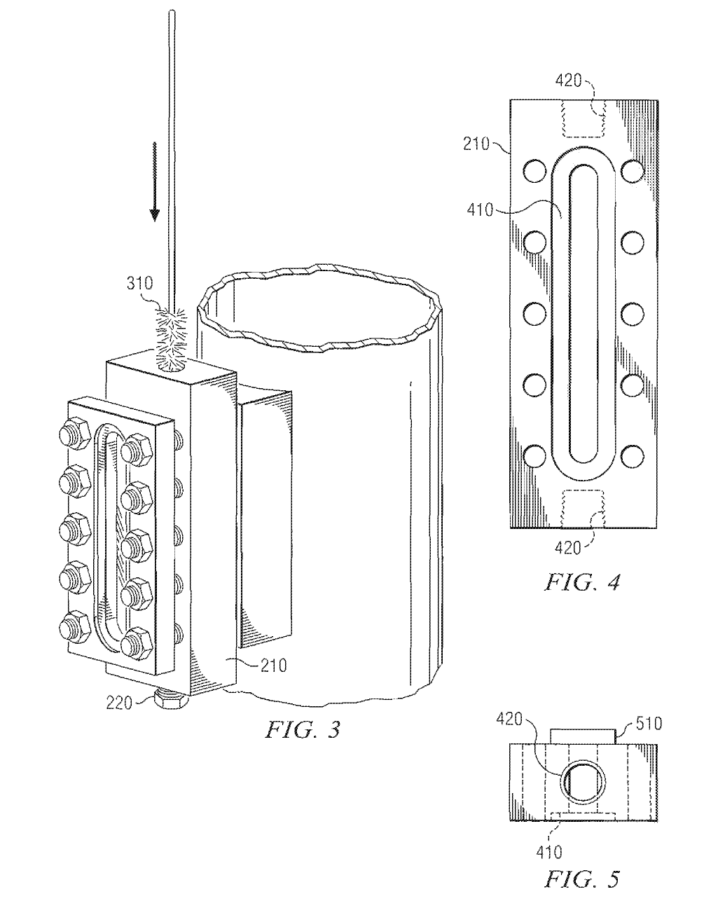

FIG. 3 is a perspective view of a cleanable welded base sight glass in accordance with an embodiment of the invention showing a brush 310 being inserted to clean the sight glass. Whenever the sight glass needs to be cleaned, one or both of the plugs 220 is removed from the end of the adapter plate 210 and the brush 310 is inserted such that when it is inserted it brushes the sight glass and thereby cleans its without removal or disassembly of the sight glass. This saves substantial time and effort and helps prevent neglect of sight glass cleaning due to the resources that are currently required to clean sight glasses such as those identified in FIG. 1. A solvent or cleaning solution can also be poured into the top port to aid in cleaning the sight glass. If the bottom plug 220 is also removed, this will allow virtually all of the cleaning solution to exit through the bottom port so as to help avoid contamination of the vessel to which the sight glass assembly is attached.

FIG. 4 is a front view of an adapter plate in accordance with an embodiment of the invention. A recessed area 410 similar to the recessed area existing on the base 120 illustrated in FIG. 1 and FIG. 2 is provided on the front portion of the adapter plate 210. A gasket fits in the recessed portion of the adapter plate and the sight glass mates with the gasket prior to the securing of the glass in place by another gasket and the top plate 110. Also illustrated are threaded ports 420 that are used to access the back side of the glass for cleaning.

FIG. 5 is a top view of an adapter plate in accordance with an embodiment of the invention. FIG. 5 shows the recessed gasket area 410, a protruding area 510 for mating with the welded base 120, and a threaded port 420 for accessing the back side of the glass when assembled into the recessed area 410.

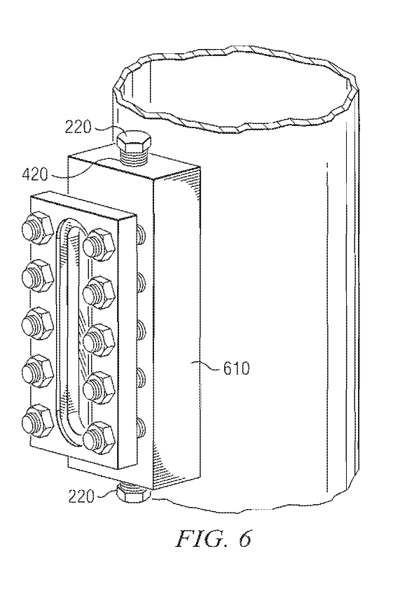

FIG. 6 is a perspective view of a welded sight glass wherein the welded base plate 610 is adapted for cleaning the sight glass in accordance with an embodiment of the invention. In this embodiment, the seal pot or other piece of equipment is originally manufactured with a welded base plate 610 that contains threaded ports 420 for the installation of plugs 220. This avoids the necessity of using an adapter plate 210 for newly manufactured equipment.

Although the present invention has been described in terms of an exemplary embodiment, it is not limited to these embodiments and modifications. Alternative embodiments, modifications, and equivalents, which would still be encompassed by the invention, may be made by those of ordinary skill in the art, in light of the foregoing teachings. Therefore, the following claims are intended to cover any alternative embodiments, modifications, or equivalents which may be included within the spirit and scope of the invention defined by the claims.

I claim:

1. A cleanable welded base sight glass assembly comprising:
a base plate welded to a vessel having a recessed area capable of receiving a sight glass;
a top plate for securing said sight glass;
an adapter plate having at least one pluggable cleaning port for cleaning said sight glass wherein said adapter plate is disposed between said base plate and said top plate; and
a plurality of fasteners for securing said top plate and said adapter plate to said base plate.

2. The sight glass assembly of claim 1 wherein said adapter plate further comprises a protruding area for meshing with said recessed area of said base plate and a recessed area for receiving said sight glass.

3. The sight glass assembly of claim 2 wherein said at least one pluggable cleaning port is located on at least one end of said adapter plate such that when a cleaning brush is inserted through said port, said cleaning brush can be used to clean a back side of said sight glass.

4. The sight glass assembly of claim 1 further comprising at least one plug for plugging said at least one pluggable port.

5. The sight glass assembly of claim 1 wherein said plurality of fasteners comprises a plurality of studs that extend into a plurality of threaded holes in said base plate and wherein said adapter plate and said top plate have a plurality of holes that match the arrangement of said plurality of studs such that said adapter plate and said top plate can be assembled onto said studs and secured in place with a plurality of nuts.

6. The sight glass assembly of claim 1 wherein said at least one pluggable cleaning port comprises a first port located on a top side of said adapter plate and a second port located on a bottom side of said adapter plate.

7. An adapter plate for retrofitting a welded base sight glass to enable cleaning of said sight glass without removing said sight glass, said welded base sight glass having a welded base plate with a recessed area for receiving said sight glass and a top plate for securing said sight glass to said base plate, said adapter plate comprising:
a back side having a protruding area for mating with said recessed area of said base plate;
a front side having a recessed area substantially similar to said recessed area of said base plate for receiving said sight glass;
a plurality of holes in said adapter plate that match the arrangement of a plurality of holes in said base plate; and
at least one port located to allow for cleaning of said sight glass through said port when said adapter plate is assembled together between said top plate and said welded plate.

8. The adapter plate of claim 7 wherein said adapter plate has a length that is longer than a length of said base plate such that a plug can be installed in said port without interfering with said sight glass.

9. The adapter plate of claim 7 wherein said at least one port comprises a first port located on a top side of said adapter plate and a second port located on a bottom side of said adapter plate.

10. A cleanable welded base sight glass assembly comprising:
a sight glass;
a base plate welded to a vessel having a recessed area capable of receiving said sight glass and at least one pluggable cleaning port for cleaning said sight glass;
a top plate for securing said sight glass to said base plate; and
a plurality of fasteners for securing said top plate to said base plate.

11. The sight glass assembly of claim 10 wherein said at least one pluggable cleaning port is located on at least one end of said base plate such that when a cleaning brush is inserted through said port, said cleaning brush can be used to clean a back side of said sight glass.

12. The apparatus of claim 11 further comprising at least one plug for plugging said pluggable port.

13. The sight glass assembly of claim 10 wherein said plurality of fasteners comprises a plurality of studs that extend into a plurality of threaded holes in said base plate and wherein said said top plate has a plurality of holes that match the arrangement of said plurality of studs such that said top plate can be assembled onto said studs and secured in place with a plurality of nuts.

14. The sight glass assembly of claim 10 wherein said at least one pluggable cleaning port comprises a first port located on a top side of said adapter plate and a second port located on a bottom side of said adapter plate.

15. A method of cleaning a welded base sight glass assembly comprising the steps:
removing a first plug from a first cleaning port wherein said cleaning port is located in a plane situated adjacent to a back side of said sight glass;
cleaning said sight glass through said cleaning port without disassembling said sight glass; and
reinstalling said plug in said cleaning port.

16. The method of claim 15 wherein said step of cleaning comprises inserting a brush through said first cleaning port and rubbing said brush against said back side of said sight glass.

17. The method of claim 16 further comprising the step removing a second plug opposite said first plug to expose a second cleaning port and cleaning said sight glass by inserting a brush through said first cleaning port and pushing out through said second cleaning port and then pulling said brush back through said second cleaning port and said first cleaning port.

18. The method of claim 17 wherein said first cleaning port is located on a top side of said welded base sight glass assembly and said second cleaning port is located on a bottom side of said welded base sight glass assembly and further comprising the steps introducing a cleaning solution into said first cleaning port to assist with cleaning said sight glass assembly and allowing substantially all of said cleaning solution to drain out through said second cleaning port.
